(19) United States
(12) Patent Application Publication
(10) Pub. No.: US 2015/0033009 A1
(43) Pub. Date: Jan. 29, 2015

(54) Method and System for Authenticating a User by an Application

(71) Applicant: SIEMENS AKTIENGESELLSCHAFT, München (DE)

(72) Inventor: Andreas Köpf, Munchen (DE)

(21) Appl. No.: 14/385,163

(22) PCT Filed: Feb. 6, 2013
(86) PCT No.: PCT/EP2013/052319

§ 371 Date: Sep. 14, 2014

(30) Foreign Application Priority Data
Mar. 14, 2012 (DE) DE 102012204024.2

(51) Int. Cl. H04L 9/32; H04L 29/06; G06F 21/31

(52) U.S. Cl. CPC H04L 9/3271; G06F 21/31; H04L 63/168; H04L 63/045; G06F 2221/2103; H04L 2463/041
USPC 713/152

(57) ABSTRACT

The invention relates to a method for authenticating a user by an application by means of a challenge-response method. In this case, the challenge (5) is displayed in the form of a barcode on a display (6) and is transmitted to a communication device (3) associated with the user. The determined response (8) is input by the user at a user interface (10) of the application.

This application is the National Stage of International Application No. PCT/EP2013/052319, filed Feb. 6, 2013, which claims the benefit of German Patent Application No. DE 10 2012 204 024.2, filed Mar. 14, 2012. The entire contents of these documents are hereby incorporated herein by reference.

### BACKGROUND

The present embodiments relate to a system and a method for authentication of a user by an application using a challenge/response method.

A large number of applications and web applications use password input for the purpose of authenticating the user in order to confirm the identity of the relevant authorized user. On account of the large number of passwords that are used, the passwords are consequently often uncomplex, or the same password is used for many applications.

A further option for authenticity checking is the challenge/response method. Such a challenge/response method involves the user being authenticated by the application via a random “challenge” being generated and the challenge being sent to a communication appliance (e.g., laptop, smartphone) of the user. The communication appliance calculates the “response” associated with this “challenge” using a secret key and returns the “response” to the application. The application then checks the response received from the communication appliance for correctness. The challenge/response protocol is designed such that only the communication appliance that has the correct secret key is able to calculate the correct response.

However, in all cases this uses a data connection between application and communication appliance. The data connection uses authentication in order to set up a confidential data connection, however. In addition, data communication between application and communication appliance is also a potential weakness of such a method.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a method and a system for authentication of a user by an application that avoids the aforementioned disadvantages and at the same time provides as high a level of security as possible are provided.

According to one or more of the present embodiments, a method for authentication of a user by an application using a challenge/response protocol includes generating a challenge and output of the challenge in the form of a barcode by the application. The method also includes reading-in the challenge by a mobile communication appliance of the user, and ascertaining a response by the mobile communication appliance of the user based on the read-in challenge and a first secret key that is associated with the user. The method includes presenting the ascertained response by the mobile communication appliance, and checking the response by the application following input of the presented response into the application by the user.

According to one embodiment, a symmetric cryptographic method is used for the challenge/response protocol. The application has the first secret key available in the symmetric cryptographic method.

According to a further embodiment, an asymmetric cryptographic method having an asymmetric key pair including a private key and a public key is used for the challenge/response protocol. The private key is known only to the mobile communication appliance of the user.

According to a further embodiment, the application has the public key of the asymmetric key pair available.

According to a further embodiment, the public key is transmitted to the application in a certificate that is associated with the user.

According to a further embodiment, the certificate transmitted by the mobile communication appliance of the user is checked by the application for validity, and the check on the validity of the certificate is carried out by using a further public key.

The system according to one or more of the present embodiments for authentication of a user by an application based on a challenge/response protocol includes a computer platform for performing the application. The computer platform includes a first authentication module for generating a challenge and for checking a received response. The computer platform also includes a first communication module for output of the challenge in the form of a barcode on a display and for input of the response by a user. The computer platform also includes a mobile communication appliance of the user. The mobile communication appliance includes a second communication module for automatically reading in the output challenge and for presenting the ascertained response on a display, and a second authentication module that ascertains the response associated with the read-in challenge.

According to a development of the system, each of the first and second authentication modules has a computation module provided for calculations, checks and authentications within the respective authentication module.

### BRIEF DESCRIPTION OF THE DRAWINGS

FIG. 1 shows one embodiment of an authentication method.

### DETAILED DESCRIPTION

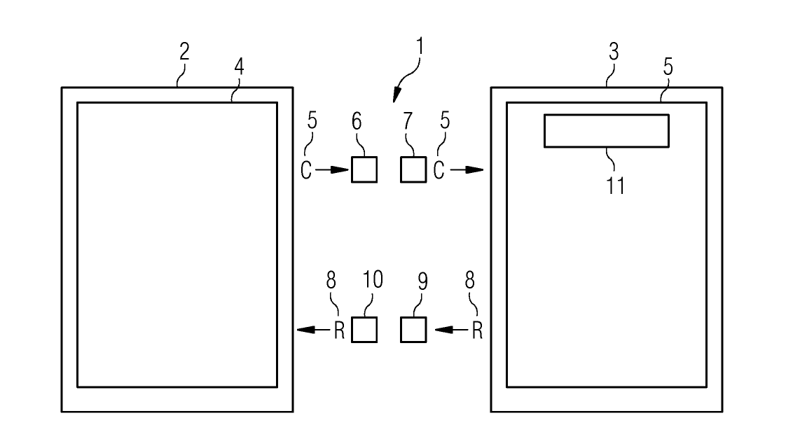

FIG. 1 shows a computer platform for performing an application 2 and a mobile communication appliance 3 of a user of a system 1 according to one or more of the present embodiments for authentication of a user by an application based on a challenge/response protocol. FIG. 1 shows authentication modules 4, 5 within these devices 2, 3.

The authentication method according to one or more of the present embodiments takes place as follows. At the beginning of the authentication method, the authentication module 4 of the application produces a challenge C. The authentication module 4 sends this challenge C as a challenge signal 5 to the display 6, on which the response R, presented as a barcode, is displayed in visible form. The communication device 3 uses an optical scanner 7 (e.g., a camera) to read in the data displayed on the display 6. The authentication module 5 next calculates the response R that matches the challenge C. The authentication module 5 then sends the response R as a response signal 8 to the display 9, on which the response R, presented in alphanumeric form, for example, is displayed in visible form. The displayed data is input by the user on a user interface 10 of the application 2 and is made available to the authentication module 4 as a response R. The authentication module 4 checks the response R. If the check on this data R is positive, the user is authenticated to the application 2 by the communication appliance 3, so that subsequently the actual use of the application 2 by the user may take place.

The method described above is suited to symmetric and asymmetric authentication methods. In the case of a symmetric authentication method, both the application and the communication appliance have the same secret key available. In the case of an asymmetric authentication method, an asymmetric key pair including a private and a public key exists. The private, secret key is known only to the communication appliance of the user.

The public key may be made known by two options for the application. The first option is that the public key is already known to the application. The second option involves the public key being incorporated into a certificate 11 that is associated with the communication appliance and is made accessible to the application by the communication appliance.

One or more of the present embodiments allow registration via a 2D barcode for an applications running locally on the PC or internal web applications, for example.

Suitable communication appliances that may be provided include, for example, smartphones having a built-in digital camera. According to one embodiment, the memory of the communication appliance stores a certificate. The application therefore provides a 2D barcode that is a “challenge”. A private key is used to generate an associated response and to present the associated response as a number. This number is displayed on the display of the smartphone, for example. This number may be used by the user to register on the application. Since the response is produced using a private key (certificate), personalized access is provided.

Advantageously, it is therefore no longer necessary for a user to remember a respective password for local applications and internal web applications. In addition, a wired or wireless data connection between application and communication appliance of the user is no longer necessary.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for authentication of a user by an application using a challenge/response protocol, the method comprising:
generating, by the application, a challenge and outputting the challenge in the form of a barcode;
automatically reading-in, by a mobile communication appliance of the user, the challenge;
ascertaining a response by the mobile communication appliance of the user based on the read-in challenge and a first secret key that is associated with the user;
presenting the ascertained response by the mobile communication appliance; and
checking the response by the application following input of the presented response into the application by the user.

2. The method of claim 1, wherein a symmetric cryptographic method, in which the first secret key is available to the application, is used for the challenge/response protocol.

3. The method of claim 1, wherein an asymmetric cryptographic method having an asymmetric key pair comprising a private key and a public key is used for the challenge/response protocol, and
wherein the private key is known only to the mobile communication appliance of the user.

4. The method of claim 3, wherein the application has the public key of the asymmetric key pair available.

5. The method of claim 3, wherein the public key is transmitted to the application in a certificate that is associated with the user.

6. The method of claim 5, further comprising:
checking, by the application, the certificate transmitted by the mobile communication appliance of the user for validity,
wherein the check on the validity of the certificate is carried out by using a further public key.

7. A system for authentication of a user by an application based on a challenge/response protocol, the system comprising:
a computer platform configured to perform the application, the computer platform comprising:
a first authentication module configured to generate a challenge and check a received response; and
a first communication module configured to output the challenge in the form of a barcode on a display and input the response by the user; and
a mobile communication appliance of the user, the mobile communication appliance comprising:
a second communication module configured to automatically read in the output challenge and present the ascertained response on a display; and
a second authentication module configured to ascertain the response associated with the read-in challenge.

8. The system of claim 7, wherein each of the first authentication module and the second authentication module has a computation module that is provided for calculations, checks and authentications within the respective authentication module.

9. The system of claim 7, wherein a symmetric cryptographic method, in which the application has a first secret key available, is used for the challenge/response protocol.

10. The system of claim 7, wherein an asymmetric cryptographic method having an asymmetric key pair comprising a private key and a public key is used for the challenge/response protocol, and
wherein the private key is known only to the mobile communication appliance of the user.

11. The system of claim 10, wherein the application has the public key of the asymmetric key pair available.

12. The system of claim 10, wherein the public key is transmittable to the application in a certificate that is associated with the user.

13. The system of claim 12, wherein the application is configured to check the certificate transmitted by the mobile communication appliance of the user for validity, and
wherein the check on the validity of the certificate is carried out with a further public key.
